(19) United States
(12) Patent Application Publication
(10) Pub. No.: US 2007/0263316 A1
(43) Pub. Date: Nov. 15, 2007

(54) Method And Apparatus For Supporting And Orienting A Workpiece And A Workpiece For Use Therewith

(75) Inventor: Michael John Unger, Bloomingdale, IL (US)

Correspondence Address: FITCH EVEN TABIN AND FLANNERY, 120 SOUTH LA SALLE STREET, SUITE 1600, CHICAGO, IL, 60603-3406, US

(73) Assignee: DICKSON/UNIGAGE, INC., Addison, IL (US)

(21) Appl. No.: 11/557,825

(22) Filed: Nov. 8, 2006

Related U.S. Application Data
(63) Continuation-in-part of application No. 29/246,812, filed on May 11, 2006.

(51) Int. Cl. G11B 5/596

(52) U.S. Cl. 360/78.05

(57) ABSTRACT

A method and apparatus for supporting and orienting a workpiece and a workpiece for use therewith. In one form, the apparatus for supporting and orienting the workpiece includes a body having first and second mating structures for connecting the apparatus to a data recorder and connecting the workpiece to the apparatus, respectively, and an indexing mechanism for orienting the workpiece so that it may be connected to the apparatus in no more than one orientation per side. The workpiece for use therewith further includes first and second openings which correspond to the second mating structure and indexing mechanism so that the workpiece may be connected to the apparatus in no more than one orientation per side. The apparatus and workpiece further provide methods for supporting and orienting the workpiece so that the workpiece may be connected to the apparatus in no more than one orientation per side.

### CROSS REFERENCE TO RELATED APPLICATIONS

This application is a continuation-in-part of U.S. Design Patent Application No. 29/246,812 filed May 11, 2006, which is hereby incorporated herein in its entirety.

### BACKGROUND OF THE INVENTION

1. Field of the Invention

This invention relates generally to a method and apparatus for supporting and orienting a workpiece and a workpiece for use therewith. More particularly, the invention relates to a data recorder hub, a workpiece for use therewith, and a method of mounting and orientating the workpiece with respect to the hub.

2. Description of the Related Art

A data recorder produces a written record of conditions such as temperature, pressure, humidity, dew point, and system activity without the need for periodic manual readings. The data recorder typically includes a hub for receiving a workpiece, such as a piece of paper, for keeping track of or recording relevant data over a period of time. When operating, the data recorder uses a writing instrument to record selected data on the workpiece. In most instances, the data recorder uses a hub to rotate the workpiece while the writing instrument makes contact with the workpiece to document the conditions over a selected or predetermined period of time. Applications can include quality control during transport and storage, regulatory compliance, and environmental control. Thus, accurate and precise readings are desired.

One drawback of traditional data recorders was workpiece slippage during rotation, causing inaccurate and imprecise readings. Most slipping occurs when the hub does not sufficiently secure or grip the workpiece. Attempts were made to solve the slipping problem by using a square hub along with a square opening in the workpiece as illustrated in FIGS. 4A and 4B. Thus, rotation of the hub would result in a corresponding rotation of the workpiece due to the mating engagement between the square hub and the square opening in the workpiece. The more securely the workpiece was mounted, the more accurately the data would be recorded.

However, the square hub and workpiece opening still produced unwanted play between the workpiece and the hub. Thus, the hub was designed to incorporate multiple structures that provided several points of attachment to further reduce play between the hub and the workpiece, as illustrated in FIGS. 5A, 5B, 6A, and 6B. The hub used multiple points of attachment to the workpiece to help reduce excessive workpiece movement and therefore, produced measurements that were more accurate than before. The two half-circle design of FIGS. 5A and 5B and the four-post design of FIGS. 6A and 6B are examples of how multiple structures have been used on the hub to reduce play or latitude in the system.

Although the problems with slippage and play have been addressed, there remain other problems with regard to data recorders and workpieces that impact their performance and accuracy. For example, one shortcoming with existing data recorders and workpieces is that the workpiece can still be mounted in different orientations on the hub, thereby leaving room for the workpiece to be placed on the data recorder in an improper orientation or position. As an example, the square hub and workpiece with square opening illustrated in FIGS. 4A and 4B, allow the workpiece to be placed on the hub in four different orientations per side of the workpiece; thereby, providing eight different orientations at which the workpiece can be mounted to the hub. Similarly, the two half-circle design of FIGS. 5A and 5B allows the workpiece to be mounted to the hub in four different orientations and the four-post design of FIGS. 6A and 6B allows the workpiece to be mounted to the hub in eight different orientations. The large number of possible orientations, makes it more complicated and/or difficult for the user to efficiently mount the workpiece in the proper orientation and increases the likelihood that the workpiece will not be mounted in the proper orientation over time.

Another shortcoming with existing data recorders and workpieces pertains to the amount of effort that is required in order to accurately set the time for the workpiece and data recorder. This too is due to the fact that existing workpieces can be mounted to the data recorder in a variety of orientations. Thus, users of existing data recorders and workpieces must either check to see which orientation would place the workpiece at the correct date and/or time, or alternatively (and more commonly) require the user to connect or mount the workpiece to the data recorder and then manually rotate the hub of the data recorder until the workpiece is positioned at the correct date and/or time.

Accordingly, a need exists for an improved method and apparatus for supporting and orienting a workpiece and a workpiece for use therewith, and more particularly, for an improved data recorder hub, workpiece for use therewith, and a method of mounting and orientating the workpiece with respect to the hub.

### BRIEF DESCRIPTION OF THE DRAWINGS

FIGS. 1A-E are perspective, front, rear, top, and side views, respectively, of an apparatus for supporting a workpiece in accordance with the present invention;

FIGS. 2A-B are perspective and exploded views, respectively of the apparatus of FIG. 1A and a workpiece for use therewith, in accordance with the present invention;

FIGS. 3A-B are front views of alternative embodiments of apparatus for supporting a workpiece in accordance with the present invention;

FIGS. 4A-B are perspective views of a prior art hub and hub and chart, respectively;

FIGS. 5A-B are perspective views of a prior art hub and hub and chart, respectively; and

FIGS. 6A-B are perspective views of a prior art hub and hub and chart, respectively.

### DESCRIPTION OF THE PREFERRED EMBODIMENTS

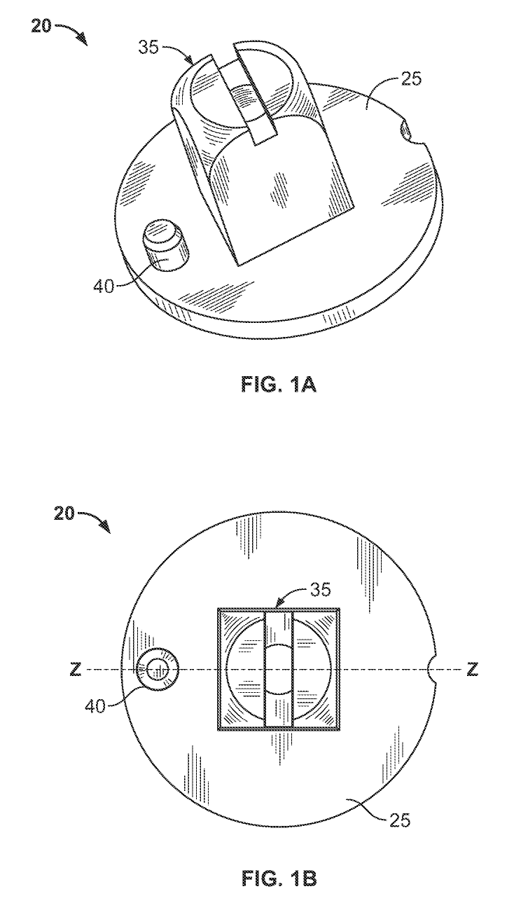

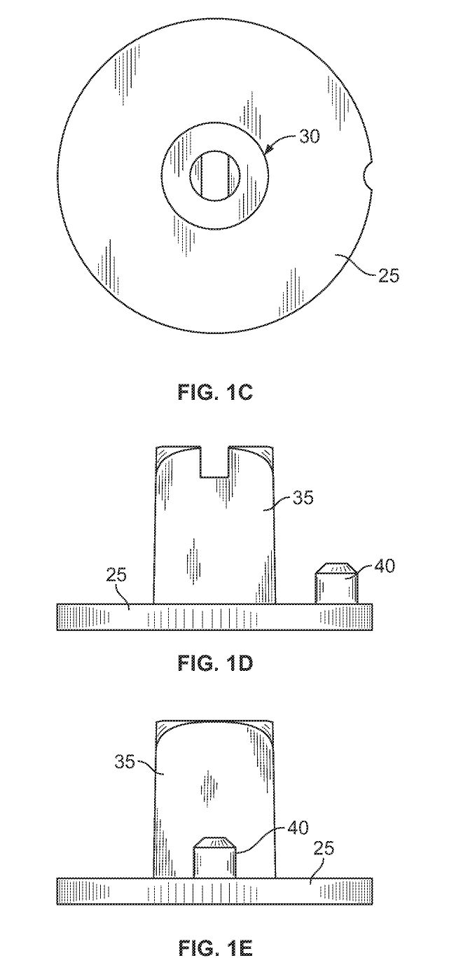

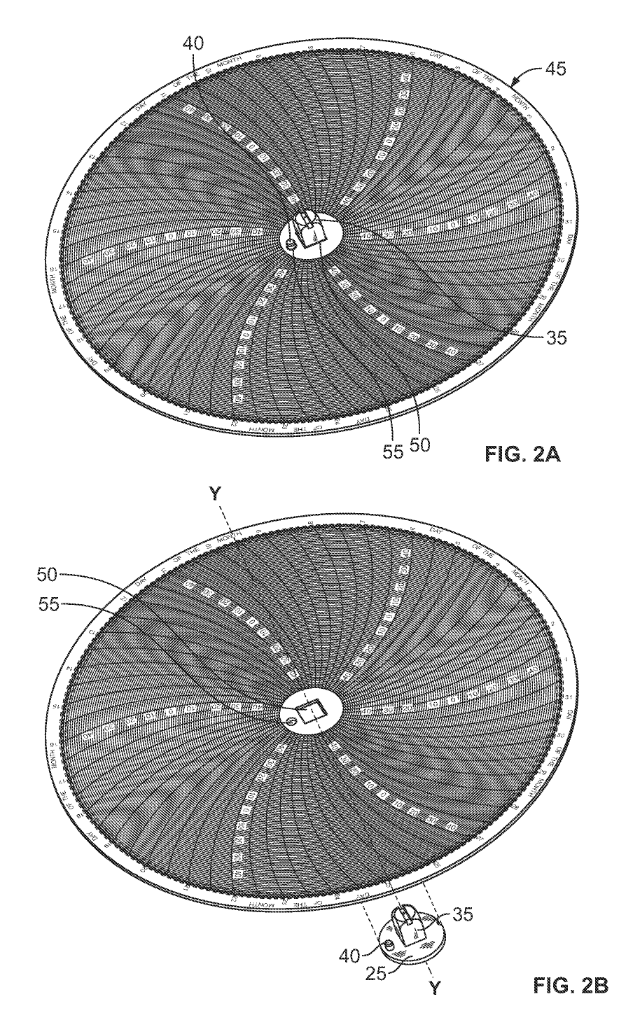

Referring now to the drawings, FIGS. 1A-E generally illustrate an apparatus, such as hub 20, for supporting and orienting a workpiece in accordance with the invention. The hub 20 works in conjunction with a workpiece, such as paper chart 45 (FIGS. 2A-B), and a data recorder, such as a chart recorder (not shown), to help document selected or desired conditions over a period of time by translating data collected by the data recorder to the workpiece 45. The hub 20 includes a body 25, first and second mating structures 30 and 35, and an indexing mechanism 40 which support and orient the workpiece 45 in the proper position on the data recorder.

In the embodiment illustrated, the body 25 is a generally thin, flat, disc-shaped structure. Upon one side of the body 25 is located the first mating structure 30 and on the opposite side is located the second mating structure 35 and the indexing mechanism 40. The first mating structure 30 engages or connects the hub 20 to the data recorder, and the second mating structure 35 engages the workpiece 45 to support or connect the workpiece 45 to the hub 20 and, thereby, to the data recorder itself. In a preferred form, the first mating structure 30 forms a sleeve that frictionally engages a drive shaft located within the data recorder so that rotation of the drive shaft translates into a corresponding rotation of the hub 20.

It should be understood, however, that other types of mating arrangements may be used to connect the first mating structure 30 and the drive shaft. For example, in another form the drive shaft could be designed as a sleeve and the first mating structure 30 could be designed as a shaft or post that frictionally engages the sleeve of the drive shaft. Similarly, in other forms, fasteners may be used in lieu of, or in combination with frictional fittings, such as for example set screws, bolts, hooks, clasps, etc.

Turning back to the embodiment illustrated in FIGS. 1A-E and 2A-B, the second mating structure 35 is also generally centrally located with respect to the body 25 and comprises a protrusion, such as a rectangular post or block, extending from the disc-shaped body 25 on a side opposite that of the first mating structure 30. The second mating structure 35 preferably corresponds in shape to the first opening 50 defined by workpiece 45 so that a mating connection is formed when the mating structure 35 is inserted into the first opening 50 as illustrated in FIG. 2A. Line Y-Y in FIG. 2B illustrates a pivot axis about which the hub 20 and workpiece 45 rotate. In the form shown, the axis of rotation (line Y-Y) preferably passes directly through the center of second mating structure 35 and first opening 50 of workpiece 45.

Again, it should be understood that the second mating structure 35, like the first mating structure 30, may be formed in any number of shapes and sizes. For example, in an alternate embodiment, the second mating structure 35 may be a post having a triangular or round cross-section or may be formed in another shape preferably having at least one flat side, edge or wall, in order to prevent slippage between the mating structure 35 and workpiece 45. In yet other forms, the second mating structure may be designed as a sleeve that engages a post member extending from the workpiece. Alternatively, the second mating structure 35 and workpiece 45 may use fasteners in lieu of, or in combination with the corresponding shapes of second mating structure 35 and workpiece 45, to form a mating relationship between the first mating structure 35 and workpiece 45.

Referring back now to FIGS. 1A-E, the hub 20 also includes an indexing or orienting mechanism 40 that, like the second mating structure 35, comprises a protrusion, such as a post or peg. As illustrated in FIG. 2B, indexing mechanism 40 is preferably located at a pre-selected or predetermined axial distance from the pivot point and is therefore rotatably offset from the pivot axis (line Y-Y). The indexing mechanism 40 may be of any shape or size, and will preferably correspond in shape to the second opening 55 in workpiece 45. In the form illustrated, the indexing mechanism 40 is connected to the body 25 on the side opposite that of first mating structure 30, and is spaced apart from second mating structure 35. With this configuration, the indexing mechanism 40 provides another point of attachment between the hub 20 and the workpiece 45, in addition to the mating structure 35 and the first opening 50 in the workpiece 45.

As shown in FIGS. 2B, the second opening 55 in the workpiece 45 mates with the indexing mechanism 40 so that when the body 25 rotates, the indexing mechanism 40 orbits around the pivot axis (line Y-Y). Thus, the indexing mechanism 40 serves several purposes with respect to workpiece movement including, but not limited to, orienting the workpiece 45 and encouraging the corresponding rotation of the workpiece due to its mating engagement with second opening 55 and limiting the play between the workpiece and the hub.

As shown in the embodiment of FIGS. 2A and 2B, the workpiece 45 is generally circular or disc-shaped and has a front and back side. The workpiece 45 defines first and second openings 50 and 55, respectively, which again preferably correspond in shape to the second mating structure 35 and the indexing mechanism 40 of hub 20, respectively. Like the layout of the second mating structure 35 and indexing mechanism 40 of hub 20, the first opening 50 of workpiece 45 is also generally centrally located with the second opening 55 spaced apart therefrom.

Indicia, such as a diagram, graph, graduated markings, other markings, or combinations thereof, may be affixed or printed upon one or both sides of the workpiece to provide a standard of measurement for the information recorded. The appropriate standard of measurement is determined by the rate that the hub 20 rotates and by the type of data being collected (e.g., temperature, pressure, humidity, dew point, etc.). For example, if the data recorder is monitoring temperature and the hub 20 completes one full rotation once per day, then the graph or indicia would be graduated into a scale of degrees and broken down into twenty-four hour increments.

In the embodiment illustrated in FIGS. 2A-B, the workpiece 45 is measuring temperature and makes one full rotation per month. Thus, the workpiece 45 is divided into thirty-one day increments and gradations of temperature are provided in order to record temperature data for the entire month. When in operation, the data recorder rotates the hub 20 around the axis of rotation (line Y-Y), which in turn causes the workpiece 45 to rotate due to the mating relationship between the second mating structure 35 and the first opening 50 of workpiece 45.

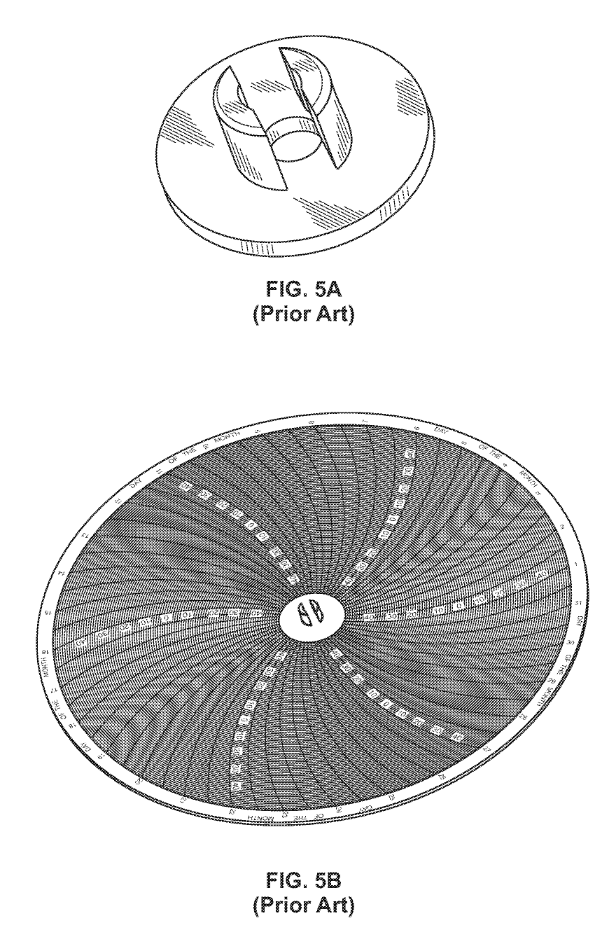

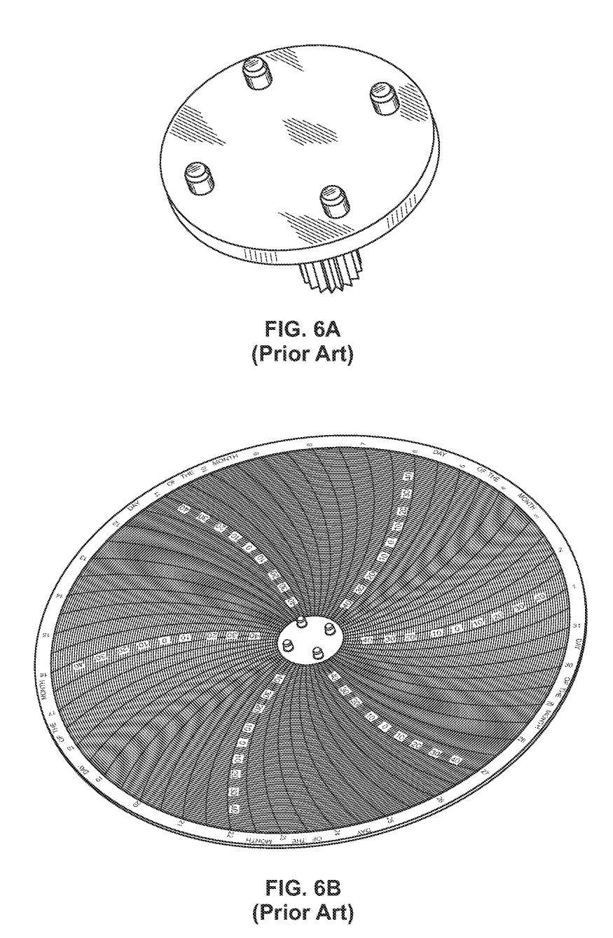

While the body 25 of hub 20 is illustrated as disc-shaped, it should be understood that alternate embodiments of the hub may be configured in various other shapes and sizes, such as for example, rectangular or triangular shapes. Similarly, while the shapes of the second mating structure 35 and first opening 50 are illustrated as rectangular or square, it should be understood that alternate shapes such as triangles or other polygonal shapes, or even non-polygonal shapes (however, preferably having at least one flat or straight wall, edge or side), may be used. It also should be understood that the second mating structure 35 may be made up of a plurality of structures, such as for example the two half or semi-circular designs of FIGS. 5A-B or the multi-post design of FIGS. 6A-B, and that the first opening 50 may be made up of a plurality of openings corresponding to the shape of the second mating structure 35.

In the embodiment illustrated in FIGS. 1A-E, the second mating structure 35 and indexing mechanism 40 are aligned so that the hub 20 is symmetrical about line Z-Z (FIG. 1B), which is the only line of symmetry for the hub. With this configuration, indicia can be printed on both sides of the workpiece 45 so that both sides of the workpiece can be used to record data, if desired. If such a configuration is employed, the indexing mechanism 40 will again only allow the workpiece 45 to be placed in one orientation per side to ensure that the workpiece is not improperly positioned, which will allow the operator to replace the workpiece quicker and more efficiently. For example, since the workpiece 45 only attaches in one orientation per side, a person trying to mount the workpiece does not have to check to see which direction would place the workpiece at the correct date and/or time, nor does a user have to manually adjust the workpiece to the correct day and/or time after attachment. This reduces the risk for error and the amount of time it takes to setup the data recorder and/or replace the workpiece mounted on the data recorder.

In other embodiments, the same configuration may be used, however, indicia may be applied to only one side of the workpiece so that it effectively can only be placed or mounted in one orientation that will record data. For example, if only one side of the workpiece is marked with indicia to keep track of the data to be recorded, the workpiece can only be placed on the hub 20 in one orientation that will allow the marking device of the data recorder to record the data being tracked on the workpiece. This too reduces the risk for error and the amount of time it takes to setup the data recorder and/or replace the workpiece mounted on the data recorder. These configurations also make the data recorder more user friendly, as the user simply needs to find the side of the workpiece 45 that has indicia on it or that has not already been used to record data (in cases of double sided workpieces) and then align the openings with the corresponding hub and indexing structures.

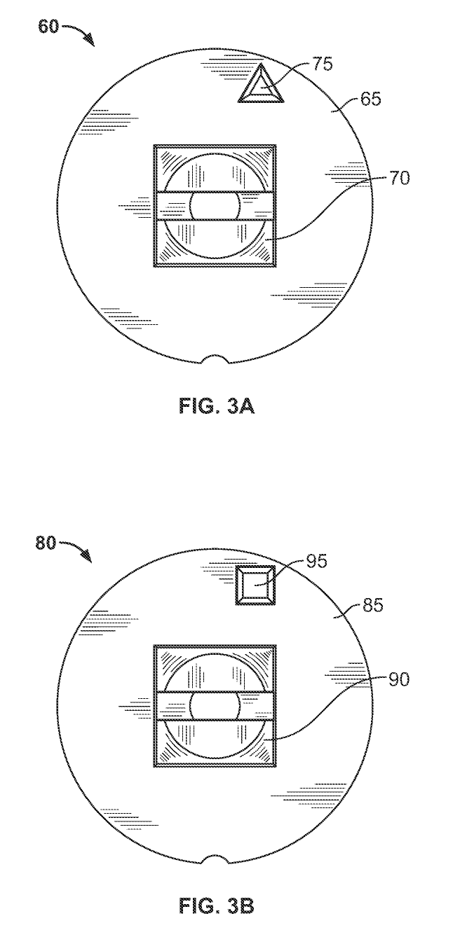

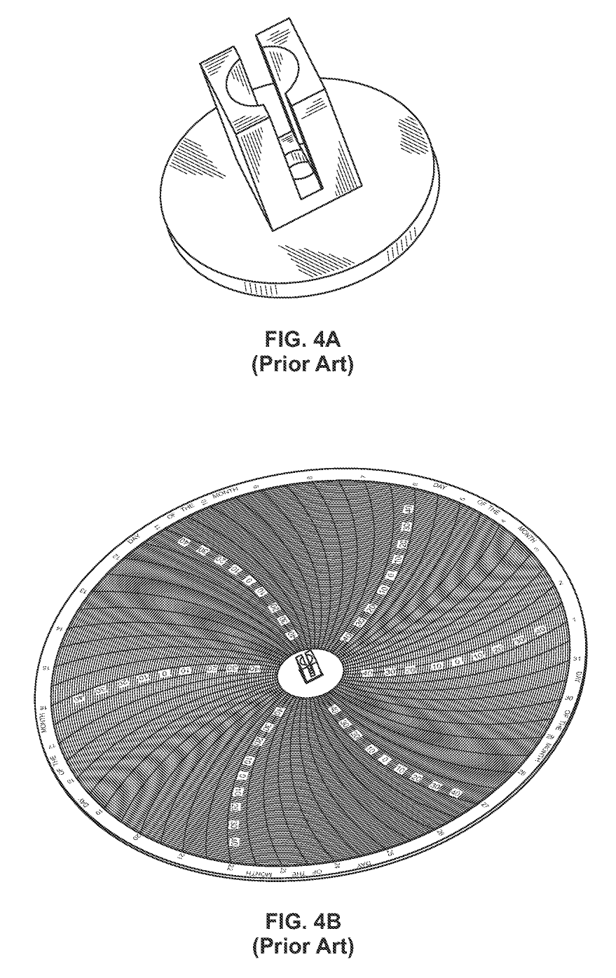

In yet other embodiments, the hub may be designed to prevent the workpiece from being placed in anything more than one orientation. For example, in FIGS. 3A and 3B asymmetrical hubs 60 and 80 are illustrated which have no lines of symmetry and only allow the workpiece to be placed on the hubs in one orientation. Hub 60 includes a body 65 having a rectangular mating structure 70 and a triangular-shaped indexing mechanism 75. Whereas, hub 80 includes a body 85 having a rectangular mating structure 90 along with a rectangular indexing mechanism 95. The indexing mechanisms 75 and 95 are positioned such that no line of symmetry can be drawn through the mating structures 70 and 90 and the respective indexing mechanisms 75 and 95. Such embodiments illustrate a few of the numerous shapes and configurations that are possible for the mating structure and indexing mechanism.

The asymmetrical hub configuration only allows the corresponding workpiece to be mounted in one direction. In other words, if a workpiece (not shown) is mounted to the asymmetrical hub 60 or 80, it cannot be flipped over and remounted thereto because the workpiece openings only align with the mating structure and indexing mechanism if the asymmetrical workpiece is positioned in the proper alignment or orientation. For the workpiece to mount properly on such asymmetrical hubs, each side of the workpiece must be facing a particular direction, either toward or away from the hub. Then each of the workpiece openings must align with the corresponding hub and indexing structures. Thus, for the asymmetrical embodiments, a user simply identifies which side of the workpiece has indicia, positions the workpiece with the indicia facing away from the hub, and then aligns the second mating structure and indexing mechanism with their corresponding openings in the workpiece and mounts the workpiece onto the hub. Thus, asymmetrical hubs such as those illustrated in FIGS. 3A-B, further reduce the risk that the workpiece will be improperly mounted to the data recorder and/or reduce the amount of time it takes to initially install and replace the workpiece in the proper orientation.

In addition to the advantages described above, hubs in accordance with the invention, such as those described herein, address other concerns by providing the workpiece 45 with two points of attachment. These two separate points of attachment confine workpiece movement, thereby increasing precision and accuracy. For example, rotation of the mating structure 35 and the indexing mechanism 40 produces a corresponding rotation of the workpiece 45. In addition to the rotation, structure 35 and mechanism 40 confine the workpiece movement to the desired rotation and help reduce (if not eliminate) slippage. Having two structures that perform these functions increases the exactness of the measurements recorded.

Exact movement of the workpiece 45 is further achieved by constructing the mating structures 30, 35 and indexing mechanism 40 of materials that are generally stiff and will not allow for much (if any) play when rotating the hub with respect to the data recorder. In a preferred method, the stiffness of hubs 20, 60 and 80 is achieved through a manufacturing process that allows for economical mass production. For example, various polymer substances will meet all required specifications and the hub 20 can be manufactured as a whole by an injection molding process, if desired.

The apparatus and methods disclosed herein may be used with any number of commercially available data recorders, such as those illustrated in Dickson's Instrumentation for Capturing Critical Data, Spring and Fall 2005 catalogs and on Dickson's www.dicksonweb.com website, which are hereby incorporated herein by reference in their entirety.

Thus it is apparent that there has been provided, in accordance with the invention, a method and apparatus for supporting and orienting a workpiece and a workpiece for use therewith, and more particularly, for an improved data recorder hub, workpiece for use therewith, and a method of mounting and orientating the workpiece with respect to the hub. Such method, apparatus and workpiece fully satisfy the objects, aims, and advantages set forth above. While the invention has been described in conjunction with specific embodiments thereof, it is evident that many alternatives, modification, and variations will be apparent to those skilled in the art in light of the foregoing description. Accordingly, it is intended to embrace all such alternatives, modifications, and variations as fall within the spirit and broad scope of the appended claims. It is also intended to embrace all methods associated with the use and operation of the apparatus discussed herein, including, but not limited to, the method of manufacturing said apparatus, and the method of securing workpieces as described herein.

What is claimed is:

1. An apparatus for supporting and orienting a workpiece comprising:
a body having a mating structure for mating with and supporting a workpiece; and
an indexing mechanism connected to the body and positioned to mate with the workpiece and prevent the workpiece from being oriented in more than one position per side.

2. An apparatus according to claim 1 wherein the body forms a hub and the mating structure is a protrusion extending from the hub for engaging an opening in the workpiece.

3. An apparatus according to claim 2 wherein the hub is disc-shaped and the protrusion is a post extending generally from the center of the hub

4. An apparatus according to claim 3 wherein the post has a generally round, rectangular or triangular cross-section and the opening in the workpiece corresponds in shape to the post to mate therewith.

5. An apparatus according to claim 2 wherein the indexing mechanism forms a second protrusion extending from the hub for engaging a second opening in the workpiece.

6. An apparatus according to claim 5 wherein the second protrusion is a post extending from a generally off-center position of the hub.

7. An apparatus according to claim 6 wherein the post has a generally round, rectangular or triangular cross-section and the second opening in the workpiece corresponds in shape to the post to mate therewith.

8. An apparatus according to claim 1 wherein the apparatus has a single line of symmetry that allows the workpiece to be mounted to the apparatus in no more than one orientation per side.

9. An apparatus according to claim 1 wherein the apparatus is asymmetrical and only allows the workpiece to be mounted to the apparatus in a single orientation.

10. A hub for supporting a workpiece on a data recorder, the hub comprising:
a body having a first mating structure for mating with the data recorder and a second mating structure for mating with at least a portion of the workpiece; and
an indexing mechanism connected to the body for orienting the workpiece into a proper position with respect to the data recorder.

11. The hub of claim 10, wherein the second mating structure of the hub is oriented opposite the first mating structure of the hub.

12. The hub of claim 10, wherein the first and second mating structures are generally centrally located upon the body.

13. The hub of claim 12, wherein the first and second mating structures define an axis of rotation for the hub and the indexing mechanism is a post that is rotatably offset from the center of the body such that the post remains a fixed distance away from the axis of rotation.

14. The hub of claim 10, wherein the first mating structure is a sleeve that is generally round, rectangular or triangular in cross-section.

15. The hub of claim 10, wherein the second mating structure is a post that is generally round, rectangular or triangular in cross-section.

16. The hub of claim 10, wherein the hub is manufactured as a whole by an injection molding process.

17. A method of mounting and orienting a workpiece on a data recorder, the method comprising:
providing a workpiece for recording data via the data recorder;
providing a hub having a first mating structure for mating with at least a portion of the workpiece and an indexing mechanism for orienting the workpiece into a proper position with respect to the data recorder; and
mounting the workpiece onto the hub such that the workpiece mates with the first mating structure of the hub and is oriented into the proper position via the indexing mechanism.

18. The method according to claim 17, wherein the first mating structure comprises a post extending from a surface of a hub and mounting the workpiece onto the hub further comprises:
inserting the post of the first mating structure into an opening defined by the workpiece to orient the workpiece with respect to the hub.

19. The method according to claim 17, wherein the hub defines a second mating structure for mating with the data recorder and the method further comprises mounting the hub to the data recorder via the second mating structure.

20. The method according the claim 17, wherein the workpiece defines first and second openings that correspond in shape to the first mating structure and the indexing mechanism, respectively, and mounting the workpiece onto the hub comprises inserting the first mating structure and indexing mechanism into the first and second openings of the workpiece to mount and orient the workpiece.

21. The method according to claim 20, wherein the workpiece has indicia placed on at least one side thereof and mounting the workpiece onto the hub further comprises inserting the first mating structure and indexing mechanism into the first and second openings of the workpiece so that the indicia is visible and accessible for recording data via the data recorder.

22. The method according to claim 17, wherein providing a hub having a first mating structure for mating with at least a portion of the workpiece and an indexing mechanism for orienting the workpiece into a proper position with respect to the data recorder further comprises positioning the indexing mechanism such that the hub has a single line of symmetry so that the workpiece can be mounted to the hub in no more than one orientation per side.

23. The method according to claim 17, wherein providing a hub having a first mating structure for mating with at least a portion of the workpiece and an indexing mechanism for orienting the workpiece into a proper position with respect to the data recorder further comprises positioning the indexing mechanism such that the hub is asymmetrical so that the workpiece can only be mounted to the hub in one orientation.

24. A workpiece for recording data from a data recorder, the workpiece comprising:
a recordable media for recording data from the data recorder, wherein the recordable media defines a first opening for mating with the data recorder and a second opening for orienting the recordable media into a proper position with respect to the data recorder.

25. The workpiece of claim 24, wherein the first opening for mating with the data recorder is generally centrally located on the recordable media.

26. The workpiece of claim 24, wherein the second opening is generally off center with respect to the recordable media, and located a pre-selected axial distance away from the first opening.

27. The workpiece of claim 24, wherein the workpiece has indicia located on at least one side thereof which helps record or make readable the data recorded by the data recorder.

28. A data recorder comprising:
a hub connected to the data recorder and rotatable with respect thereto;
a workpiece connected to the hub and rotatable therewith;
a writing implement for recording data on the workpiece; and
an indexing mechanism connected to the hub for orienting the workpiece into a proper position with respect to the data recorder.

29. The data recorder of claim 28 wherein the hub includes a first mating structure for connecting the hub to the data recorder so that the hub may be rotated with respect thereto and a second mating structure for connecting the workpiece to the hub so that the workpiece may be rotated therewith.

30. The data recorder of claim 29 wherein the first and second mating structures are located on opposite sides of the hub and are generally centered with respect to the hub, and the indexing mechanism is positioned on the same side of the hub as the second mating structure but is generally off-centered with respect to hub.

31. The data recorder of claim 30 wherein the hub has a single line of symmetry that allows the workpiece to be placed thereon in no more than one orientation per side.

32. The data recorder of claim 30 wherein the hub is asymmetrical so that the workpiece may only be placed thereon in one orientation.

33. The data recorder of claim 30 wherein the first mating structure forms a first post extending from the center of the hub and the indexing mechanism forms a second post extending from the same side of the hub as the first post, wherein the second post is spaced apart from the first post by a desired amount to allow the second post to orient the workpiece when mounted to the hub.
